(19) United States
(12) Patent Application Publication
(10) Pub. No.: US 2010/0319007 A1
(43) Pub. Date: Dec. 16, 2010

(54) EMBEDDED DEVICE AND METHOD OF STARTING NEW APPLICATION MODULE THEREIN

(75) Inventors: LIANG-MAO HUNG, Tu-Cheng (TW); JYH-GWO JU, Tu-Cheng (TW); CHIA-PENG WANG, Tu-Cheng (TW); CHUN-WEN WANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/563,230

(22) Filed: Sep. 21, 2009

(30) Foreign Application Priority Data
Jun. 15, 2009 (CN) 200910303231.9

(51) Int. Cl. G06F 9/46; G06F 3/00

(52) U.S. Cl. 719/318

(57) ABSTRACT

An embedded device includes an original application module, a new application module, and a process handling module. The original application module is capable of running in the embedded device. The new application module is capable of sending a starting request to the original application module. The process handling module is capable of receiving a command from the original application module to start up the new application module and shut down the original application module to start the new application module.

### BACKGROUND

1. Technical Field

The present disclosure relates to a method of starting a new application module and, particularly, to an embedded device and a method of starting a new application module thereof.

2. Description of Related Art

Embedded devices, for example, digital photo frames (DPFs) are becoming increasingly popular due to their convenience and ease of manipulation when implementing particular functions. However, the typical digital photo frame can only display photos.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an embedded device.

FIG. 2 is a block view of an embedded device.

FIG. 3 is a flow chart of a method of starting a new application module on an embedded device.

FIG. 4 is a flow chart of a method of shutting down a new application module on an embedded device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

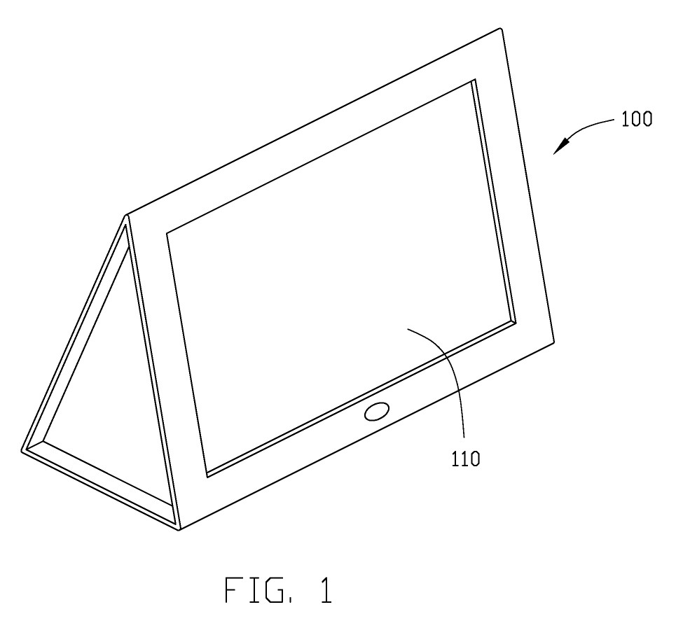

Referring to FIG. 1, a method of starting a new application module in an embedded device 100 is disclosed. The embedded device 100 may be a digital photo frame, or a digital media player, and so on. The embedded device 100 includes a display 110 and a memory. The embedded device 100 also includes a card reader, for example, a Secure Digital Memory Card reader, a Compact Flash Card reader, or an extreme digital picture card reader.

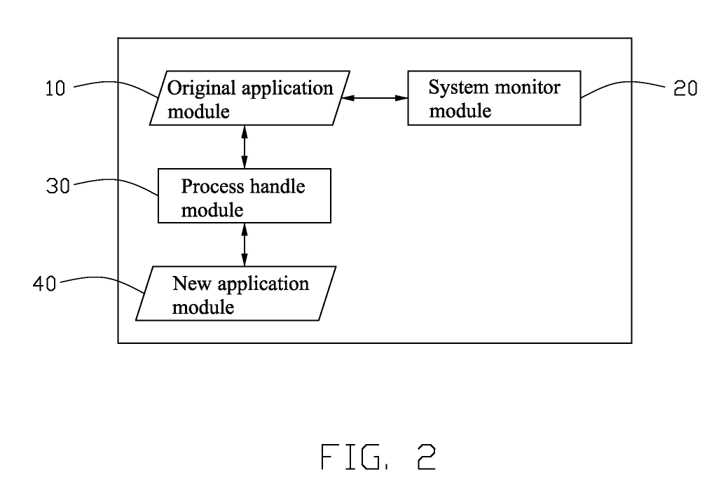

Referring to FIG. 2, the embedded device 100 includes an original application module 10, a system monitor module 20, a process handling module 30, and a new application module 40. The original application module 10 is installed in the embedded device 100. The system monitor module 20 monitors an event of starting the new application module 40 and sends an event notification to the original application module 10. The process handling module 30 is capable of shutting down the original application module 10 and starting up the new application module 40.

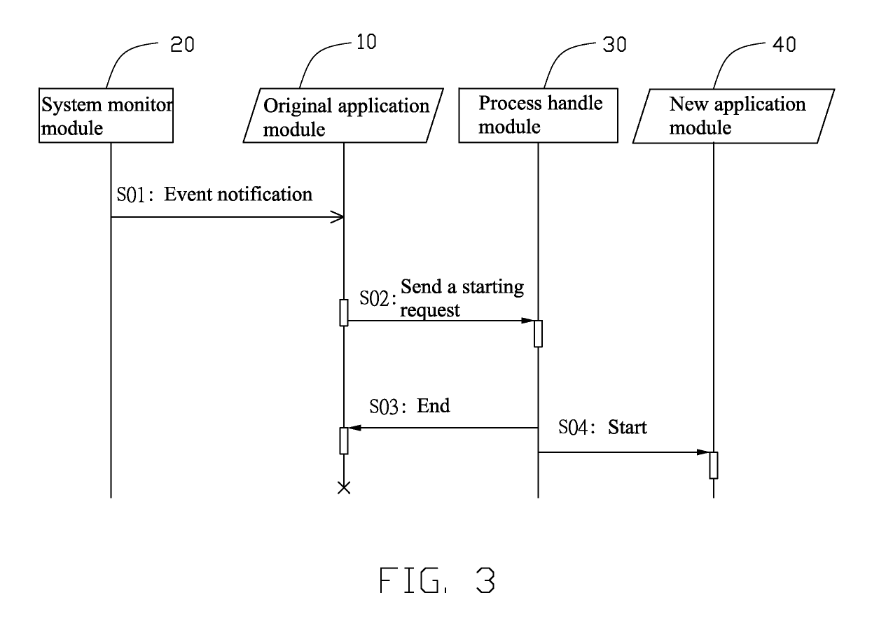

FIG. 3 is a flowchart illustrating one embodiment of a method for starting a new application module on an embedded device. Depending on the embodiment, additional blocks in the flow of FIG. 3 may be added, others removed, and the ordering of the blocks may be changed.

In block S01, the system monitor module 20 monitors an event of starting the new application module 40 and sends the event notification to the original application module 10. When there is no input after the predetermined amount of time, a screen saver module will start up. When a preset time ends, an alarm module will be turned on. The screen saver module has a slide show function or other convenient functions. The alarm module includes rings and can display text messages on the display 110.

In block S02, the original application module 10 sends a starting request to the process handling module 30 to start up the new application module 40. The original application module 10 will still be running on the embedded device 100. For example, a video application module 10 is running on the embedded device 100 when an alarm will be started. Then the video application module 10 sends the starting request to the process handling module 30 to start up the alarm.

In block S03, the process handling module 30 ends the original application module 10 after the process handling module 30 receives the starting request from the original application module 10. In block S04, the process handling module 30 starts up the new application module 40, for example, the process handling module 30 starts up the alarm module.

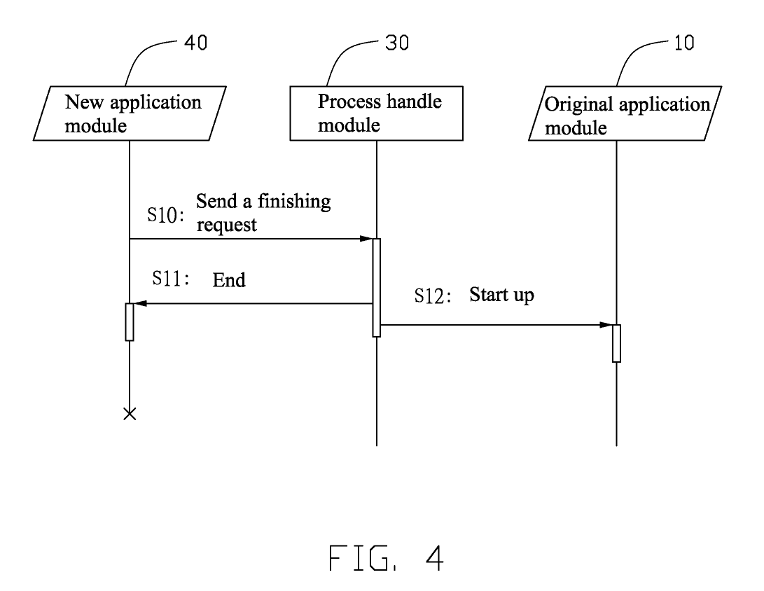

Referring to FIG. 4, a method of shutting down the new application module 40 on the embedded device 100 is disclosed. The method includes the following steps.

S10: the new application module 40 sends an end request to the process handling module 30.

S11: the process handling module 30 sends a finished command to the new application module 40 to shut down the new application module 40.

S12: the process handling module 30 starts up the original application module 40, for example, the process handling module 30 starts up the video application module 10.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method of starting a new application module in a digital photo frame, comprising:
detecting an event by a system monitor module to start the new application module;
sending a switching command to a running original application module;
the original application module sending a starting command to a process handling module to start up the new application module;
shutting down the original application module; and
starting up the new application module.

2. The method of claim 1, wherein the embedded device comprises a screen, and the original application module is displayed on the screen.

3. The method of claim 1, wherein the original application module is a user interface application module.

4. The method of claim 1, wherein the detecting an event by a system monitor module comprises detecting when no input to the embedded device in a predetermined time value.

5. The method of claim 4, wherein the new application module is a screen saver application module.

6. The method of claim 5, wherein the screen saver application module is capable of playing a piece of video, a slide show, powering off a screen of the embedded device or a combination thereof.

7. The method of claim 1, wherein detecting an event by a system monitor module comprises detecting that a preset time is reached.

8. The method of claim 7, wherein the new application module is an alarm application module.

9. The method of claim 8, wherein the alarm application module is capable of ringing or displaying text messages.

10. The method of claim 1, wherein the process handling module starts the original application module when the new application module is shut down.

11. An embedded device, comprising:
an original application module capable of running in an embedded device;
a new application module capable of sending a starting request to the original application module;
a process handling module capable of receiving a command from the original application module to start up the new application module and shut down the original application module.

12. The embedded device of claim 11, wherein a system monitor module is capable of monitoring an event of starting the new application module and sending an event notification to the original application module.

13. The embedded device of claim 12, wherein the event comprises no input in a predetermined time value.

14. The embedded device of claim 12, wherein the event comprises a preset time ending.

15. The embedded device of claim 11, wherein the process handling module is capable of ending the new application module to start the original application module after the new application module finishing.

16. The embedded device of claim 11, wherein the new application module is a screen saver module.

17. The embedded device of claim 16, wherein the screen saver module has a slide show function.

18. The embedded device of claim 11, wherein the original application module is a music application module.

19. The embedded device of claim 11, wherein the new application module is an alarm application module.

20. The embedded device of claim 11, wherein the alarm application module comprises audio and display text messages.
